(19) United States
(12) Patent Application Publication
(10) Pub. No.: US 2011/0215497 A1
(43) Pub. Date: Sep. 8, 2011

(54) POST-CURE OF MOLDED POLYURETHANE FOAM PRODUCTS

(76) Inventors: James T. McEvoy, Howell, MI (US); Ryoko Yamasaki, Ypsilanti, MI (US); Patricia McClarren, Ypsilanti, MI (US); Antoine A. Kmeid, Canton, MI (US)

(21) Appl. No.: 12/597,668

(22) PCT Filed: Sep. 22, 2009
(86) PCT No.: PCT/US09/57868

§ 371 Date: Oct. 26, 2009

Related U.S. Application Data
(60) Provisional application No. 61/099,142, filed on Sep. 22, 2008.

(51) Int. Cl. B29C 44/56

(52) U.S. Cl. 264/48; 264/425

(57) ABSTRACT

A method of manufacturing a foam product comprising molding 10 the foam product by injecting liquid material into a mold cavity; de-molding 11 the foam product by removing the foam product from the mold cavity; post-curing 20 the foam product, after de-molding 11 and prior to crushing 40 the foam product, to reduce set damage and form a superficial layer thereon by applying auxiliary heat; and crushing 40 the foam product to obtain a predetermined reduction in thickness of the foam product by mechanically compressing the foam product. The method further comprising cooling 30 the foam product, after post-curing 20 and prior to crushing 40 the foam product, by removing the auxiliary heat applied to the foam product.

### CROSS-REFERENCE TO RELATED APPLICATIONS

This application claims the benefit of and priority to U.S. Provisional Patent Application No. 61/099,142, filed Sep. 22, 2008, titled: POST-CURE OF MOLDED POLYURETHANE FOAM PRODUCTS, in the name of McEvoy et al. which is incorporated by reference herein.

### BACKGROUND

The present disclosure relates to the manufacture of molded polyurethane foam products and, more particularly, to a method of manufacture incorporating a post-cure step according to which such polyurethane products are, in an energy efficient manner, made more robust and better suited to shipping.

It is generally known to provide a molded polyurethane foam cushion for the comfort of an occupant of a seat, whether the seat is for a piece of furniture, a piece of equipment, or a vehicle, such as an automobile.

Molded polyurethane foams (both of the soft and firm varieties) may be formed by the so-called “one shot” process of mixing two streams—a first (or isocyanate) stream and a second (or polyol) stream—essentially comprised of the following components: A base polyol resin material, a copolymer polyol resin material, water, a catalyst (or catalyst package), typically an isocyanate such as, for instance, TDI, MDI or blends thereof (generally, such blends are not less than 5% of either TDI or MDI; e.g., TM20, a blend of 80% TDI and 20% MDI), and a surfactant. Various additives can, as known, be used to provide different properties.

It is generally understood to mix the above components by pouring two streams of the materials into a mold, closing the mold, and allowing the components to react. This reaction is exothermic, although auxiliary heat (approximately 150°-170° F., using an isocyanate catalyst) is typically applied to the mold to help reduce the amount of time to cure the foam and thereby more quickly produce the foam product.

Optionally, the resultant foam product is crushed in the mold using a time pressure release process (TPR process). TPR includes reducing the sealing pressure of the mold to allow gas to escape the foam and mold during cure and/or prior to being removed from the mold (i.e. “demold”). As a further option (and preferably), the demolded foam product may also be mechanically crushed (and may be repeatedly crushed) using a crushing apparatus such as a vacuum, a hard roller, or a brush crusher. This conventionally occurs as soon as 2 minutes following demold. The mechanical crushing apparatus applies a predetermined force to obtain a predetermined amount of reduction in thickness of the foam product at a particular time (e.g. from 15 seconds to 8 minutes, and more preferably from 90 seconds to 2 minutes) after demold and for a given period of crush time. Conventionally, mechanical crushing proceeds sequentially, with a first stage performing a 50% compression (i.e., compression to 50% of the original thickness of the foam), followed by a second stage performing a 90% compression, and a third stage also performing a 90% compression. The post-demold crushing operation is advantageous in providing an improved dampening of vibration through the foam product (such as, in the case of an automobile seat, the dampening of road vibration), as well as in creating improved perceived comfort of the product when employed as a seat.

Crushing is an important part of the process in manufacturing molded polyurethane seats in particular. In the absence of proper crushing, the foam product will exhibit a false hardness and, in subsequent use, will suffer height loss under compression. In the automobile industry specifically, the height at which a driver has adequate visibility (the H-point) is a critical design specification which must be accounted for in the manufacture of polyurethane seats. Improperly crushed foam seats can result in unwanted variation of the H-point. Additionally, an improperly crushed seat which later loses height under compression can cause an undesirable alteration in the seat's cosmetic appearance as the seat cover may become loose.

In a mass-production environment for the manufacture of polyurethane foam products, such as seats, crushed foam products may be placed on a monorail or other conveyor to cure for a period of time (e.g., 30-120 minutes). Afterwards, the foam products may be bagged or otherwise collectively packaged for shipment to another location for the performance of further operations (such as seat assembly, for instance). Because the foam product is generally not fully cured at demolding, if the time during which the foam products are allowed to cure on the monorail or other conveyor is too short, the foam products may still be warm enough so that, upon bagging/packaging, they may impinge on and form semi-permanent or even permanent dents or compressions in adjacent foam products. This is known as set damage. Such damaged foam products are typically rejected as waste or scrap.

Shipping costs for molded polyurethane foam products is relatively very high since the products are essentially air and so take up a relatively large volume with a relatively low mass. As fuel costs increase, these shipping costs likewise increase. The greater the degree to which polyurethane foam products may be compressed, the greater the numbers of such products which can be shipped and, thus, the more economical shipping becomes.

Previously, a post-cure step has been used in the production of molded polyurethane foam products in order to reduce set damage. As shown in FIG. 1, this post-cure step was conducted following both demolding and subsequent (typically, after approximately 2 minutes) mechanical crushing. The post-cure step took place in a gas-fired or dry-air oven where the crushed foam product was reheated at approximately 300° F. over approximately an hour back up to a core temperature near that achieved during molding (typically from approximately 180° F. up to as high as approximately 210° F.), at which core temperature the product was thereafter maintained for approximately an hour to effect further curing and the formation of a denser superficial layer caused by non-contact, surface-melting of the open cells at the foam product's surface (FIG. 2).

While beneficial in producing a molded foam product whose more dense superficial layer protected from set damage during shipping, the post-cure operation of the prior art was time-consuming. A more prevalent method for the conventional manufacture of molded polyurethane foam products, as shown in FIG. 3, therefore eliminated the above-described post-cure step. As with the method of FIG. 1, this method also uses a mechanical crushing step within approximately 2 minutes following demolding.

### SUMMARY

A method of manufacturing a foam product comprising molding the foam product by injecting liquid material into a mold cavity; de-molding the foam product by removing the foam product from the mold cavity; post-curing the foam product, after de-molding and prior to crushing the foam product, to reduce set damage and form a superficial layer thereon by applying auxiliary heat; and crushing the foam product to obtain a predetermined reduction in thickness of the foam product by mechanically compressing the foam product. The method further comprising cooling the foam product, after post-curing and prior to crushing the foam product, by removing the auxiliary heat applied to the foam product.

### BRIEF DESCRIPTION OF THE DRAWINGS

FIG. 1 is a flow chart depicting a prior art method for manufacturing molded polyurethane products which includes a post-cure operation after the crush step.

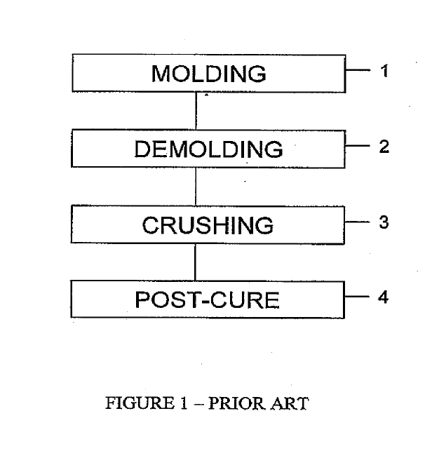

FIG. 2 diagrammatically illustrates the steps of forming a denser superficial layer on a foam product by surface-melting the open cells at the foam product's surface.

FIG. 3 is a flow chart depicting a prior art method for manufacturing molded polyurethane products which does not include a post-cure operation.

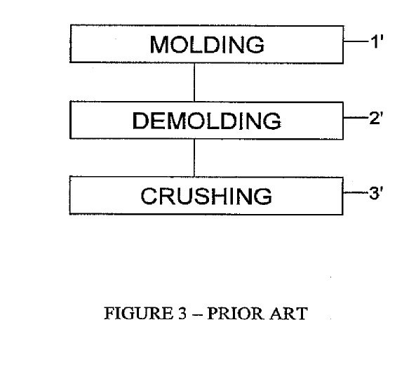

FIG. 4 is a flow-chart depicting the steps of the present disclosed method.

FIG. 5 is a graph illustrating the relationship between time and temperature through the various steps of the polyurethane manufacturing method of FIG. 1.

FIG. 6 is a graph depicting the relationship between time and temperature through the various steps of a first embodiment of the disclosure.

FIG. 7 is a graph depicting the relationship between time and temperature through the various steps of a second embodiment of the disclosure.

### DETAILED DESCRIPTION

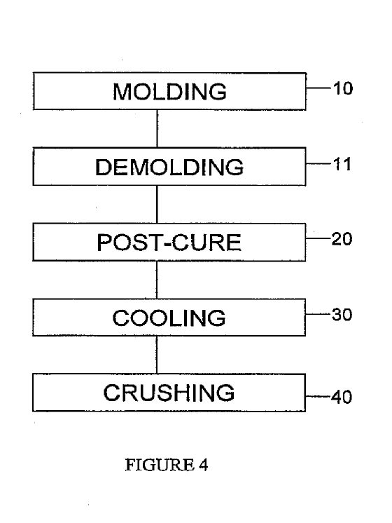

Referring generally to the FIGURES, and in particular to FIG. 4, the method of the disclosure for manufacturing molded polyurethane foam products comprises a post-cure step 20 performed after demolding 11 and prior to crushing 40. Also prior to crushing 40, the foam products are cooled 30. Except as otherwise noted, the disclosed method may proceed in conventional fashion and including known materials and methods. As used herein, “foam products” is a broad term and may comprehend, without limitation, block foams, vehicle foams (such as, for instance, seating cushions, headrests, seatback cushions, armrests, etc.), furniture seating products, and industrial foams (e.g., engine mounts, compressors, etc.).

Post-cure step 20 takes place as soon as possible following demolding 11 so that the core temperature of the polyurethane product is kept elevated to reduce/eliminate the time and energy required to perform the post-cure operation. Preferably, the post-cure step 20 stakes place within no more than a few minutes of demolding.

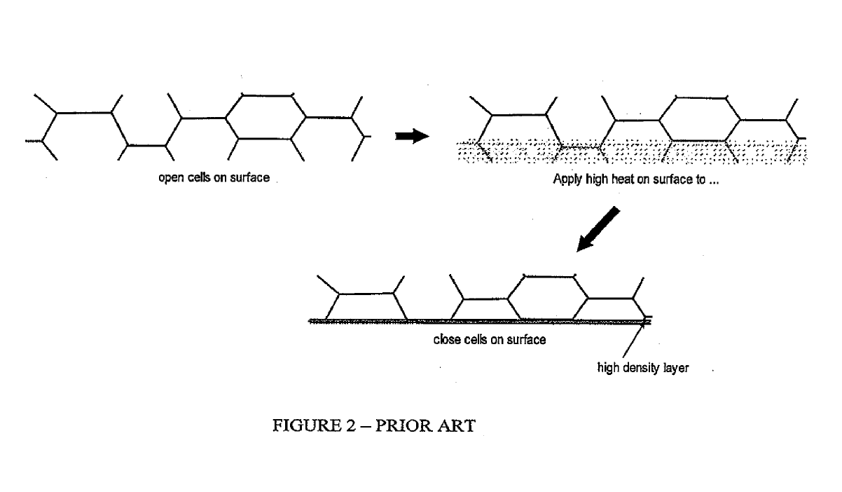

As is known, the molding step 10 is conventionally performed with the application of auxiliary heat at temperatures (typically, approximately 130°-170° F.) sufficient to accelerate curing. During this step, which is an exothermic reaction, the polyurethane product's core temperature is raised to a temperature of approximately 180°-200° F., depending upon mass. Following demolding 11, the molded foam product is heated during the post-cure step 20. The temperature at which the post-cure step 20 is performed is sufficient to effect a melting of the foam at the outer surface thereof, such as depicted diagrammatically in FIG. 2, thereby forming a denser superficial layer which renders the resultant foam product more resistant to set damage. During this post-cure step, the core temperature of the foam product will reach temperatures approximating those reached during molding 10 (in the illustrated example, approximately 180° F.). Importantly, the product is not heated to a temperature above approximately 221° F., since molded polyurethane foams have been demonstrated to lose their elastic memory when heated beyond this threshold.

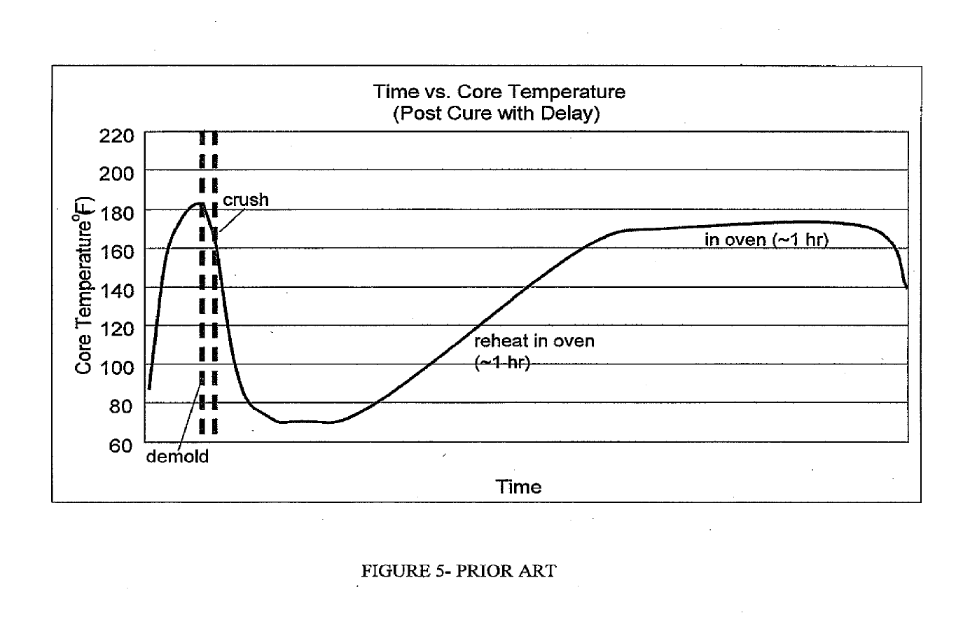

The crushing step 40 forces the exchange of gases generated in the foam product during molding with the ambient air, and so rapidly lowers the core temperature of the foam. The energy inefficiency of performing the prior art post-cure operation after crushing is manifest (FIG. 5) considering the relatively low core temperature (approximately 70° F.) of the crushed polyurethane product and, accordingly, the necessarily longer time of the post-cure step required to bring the foam product's core temperature back to an elevated temperature sufficient to effect the post-cure operation. Therefore, the crushing step of the present disclosure is not performed until after the post-cure step 20. By this arrangement, the post-cure step 20 may be performed more rapidly, and thus more efficiently, since the foam product's core temperature is at least relatively close to that achieved during the molding operation 10.

While the post-cure step 20 may be performed using any device and/or means suited to further curing of the foam product and formation of a denser superficial layer thereon, exemplary devices include any one or more of thermal curing devices, such as in a conventional industrial oven, induction heating, dielectric heating (such as with microwaves), gas-fired infrared radiant heating, UV heating, plasma heating, or electron-beam processing (which uses high-energy electrons, instead of heat, to initiate cross-linking reactions in polymers). With UV heating, plasma heating, and electron-beam processing, it will be understood that the frequency and wavelength will be material to their successful utilization.

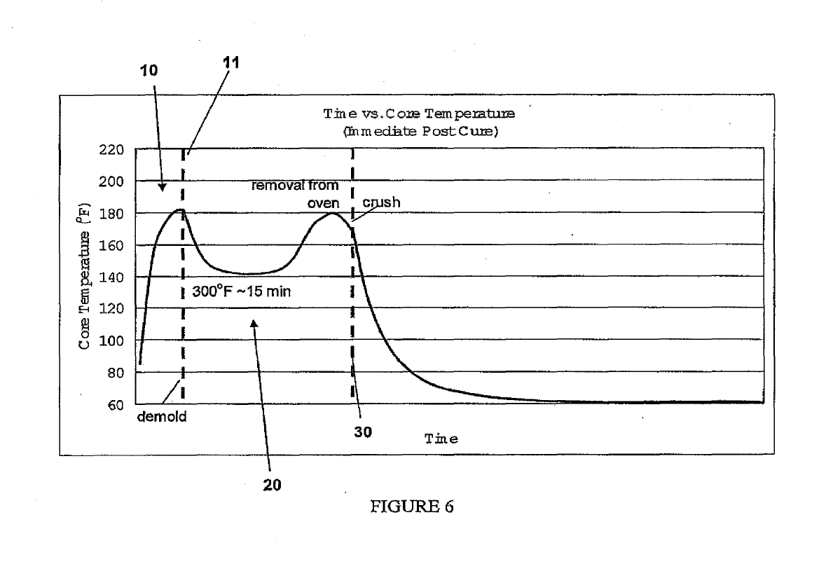

FIG. 6 is a graph depicting the relationship between time and temperature through the various steps (molding 10, demolding 11, post-cure 20 and crushing 40) of a first exemplary embodiment of the disclosure, wherein the post-cure step 20 is performed in a conventional industrial oven at a temperature of approximately 300° F. for approximately 15 minutes. As depicted, the core temperature of the polyurethane product is allowed to decrease only somewhat (to approximately 140° F.) before being elevated again to approximately 180° F. After the post-cure operation is completed, the product is cooled, crushed, and the core temperature of the product allowed to drop.

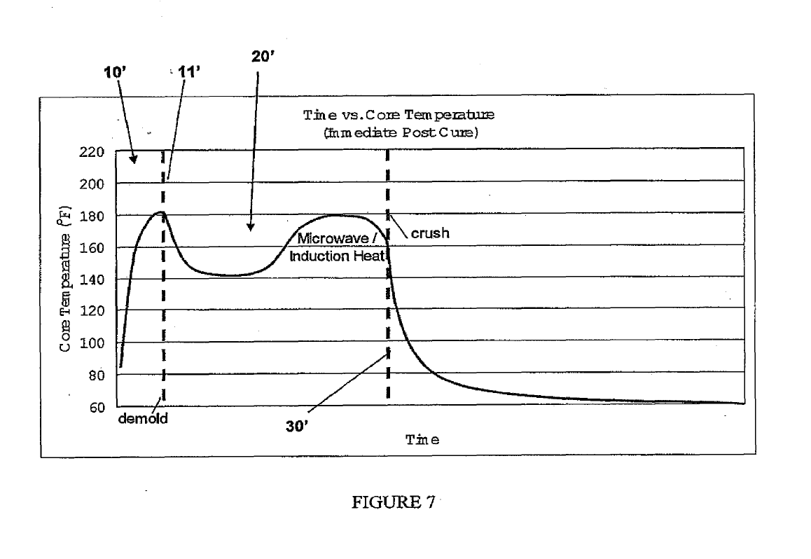

FIG. 7 is a graph depicting the relationship between time and temperature through the various steps (molding 10′, demolding 11′, post-cure 20′ and crushing 40′) of a second exemplary embodiment of the disclosure, wherein the post-cure step 20′ is performed by dielectric or induction heating. As with the embodiment of FIG. 5, the core temperature of the polyurethane product is allowed to drop only somewhat (to approximately 140° F.) before being elevated again to approximately 180° F. After the post-cure operation is completed, the product is cooled, is crushed, and the core temperature of the product allowed to drop.

To expedite heat transfer removal during the cooling 30 of the foam product before crushing, an auxiliary cooling device and/or cooling means, such as, by way of example, a high-speed fan, cooling tower, etc., may be utilized.

While the time of the post-cure step in the embodiment of FIG. 6 is as much as 15 minutes, it is contemplated that the use of certain heating means, including, by way of example only, that with means such as UV heating, plasma heating, and electron-beam processing the this time may reduced to as little as approximately 3 minutes. The time scale is not intended to be illustrated consistently among FIGS. 5-7.

The utilization of induction heating in the post-cure step 20′ will depend on the presence of electrically conducting material, also known as a susceptor, in the polyurethane foam product. It is contemplated that the susceptor may comprise a structural metal framework about which the foam product is molded.

Where the molded polyurethane product comprises a structural metal framework, one or more of the heating means exemplified above may, depending upon the type of metal, be unsuited to the post-cure step 20 if scorching results. Under such circumstances, a heating means for the post-cure step 20 which avoids scorching is preferred.

Preferably, though not necessarily, the heating means are adapted to the in-line performance of the post-cure step 20 when the disclosed method is performed in a mass-production environment, in order to further enhance the efficiency of the method.

By post-curing the foam product immediately (at zero time after de-molding) or as soon as possible after de-molding the foam product and continuing the heating of the foam product, significant productivity/manufacturing advantages (e.g., cost, etc.) over the prior art may be realized. Therefore, starting the post-curing step as soon as possible enables the foam product to require minimum heating going forward in the process of manufacturing the foam product. For example, approximately 10 seconds from de-mold to the heat source would require approximately 3 minutes of heating; approximately 30 seconds from de-mold to the heat source would require approximately 9 minutes of heating; and approximately 3 minutes from the de-mold to the heat source would require 15 minutes of heating at a higher rate of heating.

As will be understood from the foregoing description, by implementing the post-cure step as soon as possible following demolding, and before crushing, the core temperature of the polyurethane product is kept relatively high and the beneficial further curing of the molded foam product and formation of a denser superficial layer on the polyurethane product are realized in a more energy efficient manner. The superficial layer not only prevents set damage when the foam products are bagged or otherwise packaged for shipment following crushing, it may also facilitate the application of pads or other components on the product with adhesives. Further curing permits greater compression of the foam product during the crush operation, thereby yielding foam products of relatively smaller volume/higher density. Such foam products thus lend themselves to shipment in greater quantities and so improve shipping economy. Furthermore, and depending on the heating means used in the post-cure step, the post-cure step may be rendered relatively shorter and the energy efficiency thereof even further increased as compared to the method of the prior art.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the innovation. The embodiments are shown and described in order to explain the principals of the innovation and its practical application to enable one skilled in the art to utilize the innovation in various embodiments and with various modifications as are suited to the particular use contemplated.

Although only a few embodiments of the present innovations have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present innovations. Other substitutions, modifications, changes and omissions may be made in the design, operating conditions and arrangement of the exemplary embodiments without departing from the spirit of the present innovations.

What is claimed is:

1. A method of manufacturing a foam product, the method comprising the steps of:
molding the foam product by placing liquid foam materials in a mold cavity and reacting the liquid foam materials in the mold cavity to create the foam product;
de-molding the foam product by removing the foam product from the mold cavity;
post-curing the foam product after de-molding the foam product from the mold cavity and prior to crushing the foam product, to thereby maintain the core temperature of the foam product and to melt the outer surface of the foam product to form a higher density gradient thereon;
heating the foam product for between approximately two and fifteen minutes to form a higher surface densification thereon and thereby reduce set damage to the foam product;
rapidly cooling the foam product to enable the foam product to be compressed from approximately twenty-five to ninety-five percent of its thickness and thereby maximize the durability of the foam product; and
compressing the fully cured foam product from approximately fifteen and fifty percent of its dimension when packaged for shipment.

2. The method of manufacturing a foam product of claim 1, wherein the step of heating the foam product lasts between approximately three and five minutes.

3. The method of manufacturing a foam product of claim 1, wherein the step of heating the foam product lasts approximately two minutes.

4. The method of manufacturing a foam product of claim 1, the method further comprising the step of cooling the foam product, after post-curing and prior to mechanically compressing the foam product, by ceasing the heating step where heat is applied to the foam product to thereby enable the fully cured product to be compressed from approximately fifteen to fifty percent of its dimension.

5. The method of manufacturing a foam product of claim 1, wherein the post-curing step takes place within ten to thirty seconds after de-molding the foam product.

6. The method of manufacturing a foam product of claim 4, wherein the post-curing step is performed when the foam product is at a temperature sufficient to effect a melting of the outer surface of the foam product to thereby increase the higher density gradient of the foam product by a factor of one to five times.

7. The method of manufacturing a foam product of claim 5, wherein the post-cure step is performed using a post-cure device comprising at least one of: a thermal curing device, an induction heating device, a dielectric device, a gas-fired infrared radiant heating device, a UV heating device, a plasma heating device, and a electron-beam processing device.

8. The method of manufacturing a foam product of claim 7, wherein the post-cure device is a thermal curing device and the post-cure step is performed at a temperature of approximately equal to the core temperature of the foam product at the time of the de-molding step for at least approximately 15 minutes.

9. The method of manufacturing a foam product of claim 7, wherein the post-cure device is at least one of a UV heating device, a plasma heating device, and an electron-beam processing device; and wherein the post-cure step is performed at a temperature of approximately equal to the core temperature of the foam product at the time of the de-molding step for at least approximately 2 minutes.

10. The method of manufacturing a foam product of claim 9, wherein the post-cure device is adapted to the in-line performance of the post-cure step in a mass-production environment.

11. The method of manufacturing a foam product of claim 4, wherein cooling step is performed using an auxiliary cooling device such as a high speed fan and a cooling tower.

12. The method of manufacturing a foam product of claim 1, wherein the foam product comprises a molded polyurethane member.

13. The method of manufacturing a foam product of claim 12, wherein the foam product comprises a structural metal member about which the foam product is molded.

14. A method of manufacturing a foam product, the method comprising the steps of:
post-curing the foam product, after de-molding and prior to crushing the foam product, as part of the manufacturing process to form a superficial layer on the foam product by applying auxiliary heat to the foam product; and waiting for the foam product to cure completely to provide additional compression and thereby reduce set damage to the foam product.

15. The method of manufacturing a foam product of claim 14, further comprising the step of cooling the foam product after post-curing and prior to crushing the foam product by removing the auxiliary heat applied to the foam product.
